(19) United States
(12) Patent Application Publication
(10) Pub. No.: US 2006/0053755 A1
(43) Pub. Date: Mar. 16, 2006

(54) Saddles

(76) Inventor: Ronald Gordon Bates, Dalkeith (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/222,496

(22) Filed: Sep. 7, 2005

(30) Foreign Application Priority Data
Sep. 8, 2004 (AU) 2004905147

(51) Int. Cl. B68C 1/08

(52) U.S. Cl. 54/44.6

(57) ABSTRACT

A saddle for equestrian use has within its panels sealed air bags which serve to apply a relatively even pressure to the back of the horse. The air bags are within a pocket in the panel and the pocket contains adjustable packing formed by a series of replaceable foam inserts selectively insertable into the pocket to lie at the side of the air bags remote from the horse.

### BACKGROUND OF THE INVENTION

1. Field of the Invention

The present invention relates to saddles for equestrian use.

2. Description of the Prior Art

In our U.S. Pat. Nos. 6,481,189 and 6,619,019 we describe equestrian saddles in which the panels include sealed air bags. The air bags are substantially flat and contain an open celled compressible foam with air at atmospheric pressure being sealed within the bag at the time of manufacture. The air bags allow a relatively even pressure to be applied to the back of the horse during use. The interior of the panels externally of the air bags are filled with packing to permit adjustment of the fit of the saddle on the horse throughout the working life of the saddle. The packing specifically disclosed in these earlier patents is wool as has been conventionally used in packing saddle panels for many years.

It has been found that some saddlers using this system tend to overfill the packing into the panel and this can place the air bags under constant pressure. In some isolated cases this has resulted in air loss from the bags as the bags are under loading for the entire time. It also tends to push the air bags into a rounded shape which, together with the overfilling of the packing makes the panels relatively hard and the air bags do not properly perform their intended function. Moreover, the packing does tend to ride down and compress over a period of time, thereby changing the actual fit of the saddle.

### SUMMARY OF THE INVENTION

According to the present invention there is provided a saddle for equestrian use, the saddle having panels, each panel containing a plurality of sealed air bags each serving in use to apply a relatively even pressure to the back of the horse, each air bag being substantially flat and being substantially filled within its interior with a resiliently compressible open cell foam, with each air bag being filled with a predetermined volume of air at substantially atmospheric pressure at the time of manufacture without the need for inflation to a higher pressure for usage of the air bags, each panel also including packing at a side of the air bags remote from the horse, wherein the packing consists of one or more inserts of sheet-like material removably inserted into the panel to permit adjustment of the packing by removal of one or more such inserts and/or the inclusion of one or more further such inserts.

Particularly advantageously, the or each insert is fabricated from sheet material of uniform thickness although the insert itself may be chamfered or skived along at least a part of its edge. Where two such inserts are designed to overlap, for example an insert designed to be inserted into a forward part of the panel and an insert designed to be inserted into a rear part of the panel, the skives themselves will overlap to form a skive joint in order to maintain a substantially uniform thickness over the length of the two combined inserts.

A range of inserts may be provided for each panel including an insert for insertion into the forward part of the panel, an insert for insertion into the rear part of the panel and an insert for insertion into the central part of the panel. The different inserts can also be provided in a selection of different thicknesses. Accordingly adjustment of the packing to adjust the “fit” of a saddle merely requires selection of the appropriate insert of the appropriate thickness and insertion of that or those inserts into the panel.

The air bags are themselves preferably combined into an air bag unit which is itself substantially flat and the unit is inserted into a pocket extending lengthwise in the panel. For protection of the air bags, the air bag unit includes a lining layer at the side of the air bags remote from the horse and the inserts are inserted into the pocket to lie between the lining layer and an outer or upper side of the pocket. As the inserts themselves are fabricated from sheet material they will lie substantially flush against the lining layer. The lining layer itself can be associated with wedges of sheet material permanently interposed between the air bags and the lining layer to compensate for a substantially bowed shape of the base of the saddle tree to which it is adjacent.

Particularly advantageously, the sheet material from which the inserts are formed is fabricated as a relatively firm foam which will not compress or ride down significantly during use so that the fitting adjustment made to the saddle by the inclusion of the inserts remains substantially constant during use. Certain closed cell foams are suitable for this purpose.

In one practical form of the invention, the pocket is accessible for removal and insertion of the inserts after removal of the panel from the saddle with the air bags and insert(s) being retained in the pocket by a releasable closure. To facilitate easy and quick removal and replacement of the panel it is preferred to reinforce the rear edge of the panel which permits the use of a simple screw attachment system as described in our U.S. Pat. No. 6,725,636.

Further according to the invention, there is provided a saddle for equestrian use having within each of its panels sealed air bags which serve to apply a relatively even pressure to the back of the horse in use of the saddle, the air bags are within a pocket in the panel and the pocket contains adjustable packing formed by one or more replaceable foam inserts selectively insertable into the pocket to lie at the side of the air bags remote from the horse.

Still further according to the invention, there is provided a method of adjusting the packing of a saddle for equestrian use, the saddle having panels, each panel containing a plurality of sealed air bags each serving in use to apply a relatively even pressure to the back of the horse, each air bag being substantially flat and being filled with a predetermined volume of air at substantially atmospheric pressure at the time of manufacture, the air bags being within a pocket which is also adapted to receive packing at a side of the air bags remote from the horse, wherein the packing consists of one or more inserts of foam sheet material selected from a group of such inserts shaped to fit into different parts of the pocket and of at least two different thicknesses, said method comprising removal of any existing inserts from the pocket and/or inserting into the pocket one or more inserts from the group of inserts in the or each selected position and to the selected thickness.

### BRIEF DESCRIPTION OF THE DRAWINGS

Embodiments of the invention will now be described by way of example only with reference to the accompanying drawings in which:

FIG. 1 shows schematically a panel of a saddle in accordance with the preferred embodiment of the invention and including an air bag unit within the panel;

FIGS. 2 to 4 show examples of different shapes of packing insert for inclusion within the panel to lie against the air bag unit; and

FIG. 5 is a view similar to FIG. 1 and showing the packing insert of FIG. 4 within the panel.

### DESCRIPTION OF THE PREFERRED EMBODIMENTS

A saddle in accordance with the preferred embodiment of the invention has panels 2 each of which has a pocket 4 for receiving air bags and packing in the form of one or more inserts of foam which lie externally of the air bags in relation to the horse. The pocket 4 which lies adjacent to the back of the horse is part of a chamber within the panel. Other parts of that chamber such as the part towards the lower front portion of the panel may contain conventional packing. The air bags are substantially as described in our prior U.S. Pat. Nos. 6,481,189 and 6,619,019 discussed previously and the entire disclosure of which are hereby incorporated by reference. Thus, each air bag comprises opposed sheets of impervious material such as PVC sealed together around the periphery of each bag, with a filling consisting of a layer of an open cell resiliently compressible foam. The bags are not inflated with air at above atmospheric pressure and, indeed, have no means for omitting such inflation but, rather, contain air at substantially atmospheric pressure which is sealed within the bag during manufacture. The open cell foam filling occupies substantially the entirety of the interior of the bag and the bag is substantially flat and of substantially even thickness throughout. As described in our earlier patents, the air bags are arranged sequentially in a fore-aft direction within the panel. There may by just two such air bags forming front and rear air bags collectively extending the length of the panel or there may be three or possibly more air bags consisting of a front, a rear, and one or more intermediate air bags collectively extending the length of the panel and the air bags are separate in the sense that air cannot flow between the bags. Particularly advantageously, the bags are constructed as described with reference to FIG. 8 of U.S. Pat. No. 6,619,019 with overlapping flaps so that the adjacent bags are in tightly abutting relation to provide an essentially “seamless” transition between adjacent air bags.

The two or more air bags for insertion into the pocket in the panel are combined into a single unit 6 by attachment to a lining layer which extends the length of the air bag unit and which lies between the air bags and the packing insert.

The packing inserts consist of a series of pre-shaped inserts of a foam. In order to avoid the ride down and compression problems which arise with wool packing, the characteristics of the foam are such that it will not compress or ride down to any significant extent during use so that the initial fitting adjustments made by the inserts will remain substantially constant during use. A suitable foam is a relatively firm EVA foam having the properties identified in the table below.

| | | METHOD OF | STANDARD |
|---|---|---|---|
| | | TESTING | VALUE |
| hardness | ASKER C | CNS 3555 | 35-45 |
| | SHORE 00 | | 58-68 |
| density | g/cm³ | CNS 5341 | 0.09-0.12 |
| compression set | % | ASTM 3575 | 25 |
| (ASTM D-3575) | | | |
| compression | kg/cm² | ASTM 3575 | 0.9 |
| deflection 25% | | | |

It is to be noted that the above table shows the properties of an EVA closed cell foam which has been found to be particularly suitable for the purpose described. The specific properties indicated in the table are intended to represent illustrative orders of magnitude rather than defined limits and as such there may be suitable foams which have generally similar, but not identical, properties to those identified in the table. While it is envisaged that most suitable foams will be of closed cell construction they need not necessarily be of EVA; other polyolefin co-polymers may be suitable as may polyurethane, polyvinylchloride, and natural or synthetic rubbers. Indeed it is possible that open cell foams could be identified with the required characteristics.

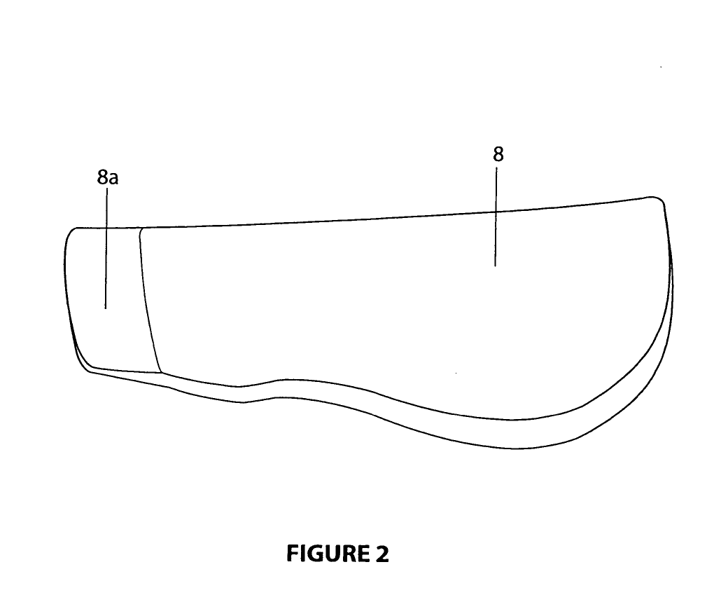

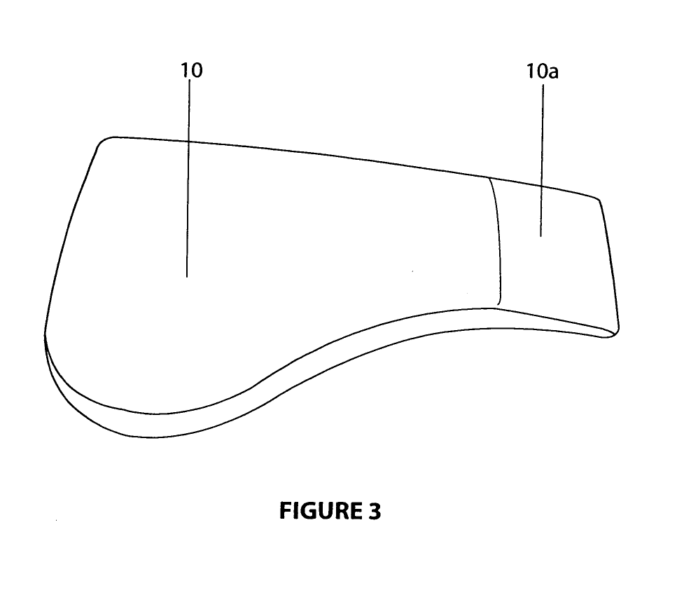

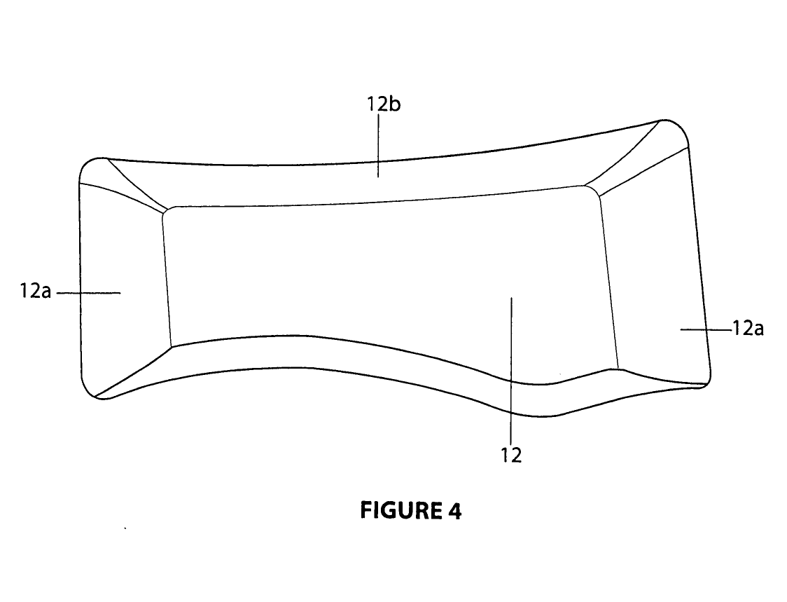

Each insert is of a generally uniform thickness over a significant part of its area. Specific inserts are designed for insertion into the front of the panel, the centre part of the panel, and the rear part of the panel. FIG. 2 shows by way of example a foam insert 8 designed for insertion at the rear of the panel. At its forward end portion the insert 8 is formed with a gradual taper or skive 8a. FIG. 3 shows an insert 10 designed to be fitted into the front of the panel and has, at its rear end portion a gradual taper or skive 10a. If the rear and front inserts 8, 10 are both inserted into the panel, the two skives 8a, 10a may overlap with their inclined faces in engagement to form a skive joint whereby the two inserts maintain a substantially uniform thickness even in their overlapping zones. Alternatively, the front and rear inserts may be of a length in which they do not overlap, and instead are able to co-operate with a central insert such as that now to be described with reference to FIG. 4. FIG. 4 shows an insert 12 which is designed to be fitted into the centre part of the panel with a gradual taper or skive 12a at each end portion.

The inserts 8-12 are formed from foam sheet of uniform thickness so that each insert is itself of uniform thickness apart from the skiving. In addition to the skiving at the ends of the inserts as described, it is also possible for the inserts to be chamfered along part of their upper and/or lower edges to provide a degree of “shaping” to the insert (this is shown schematically at 12b for the insert 12) and hence the packing provided by the insert although, as previously mentioned, each insert is of substantially uniform thickness over a significant part of its area. The skiving and chamfering can be formed by cutting the sheet with a suitable cutter. Alternatively the skiving and chamfering can be formed in the sheet by moulding the sheet with the application of heat.

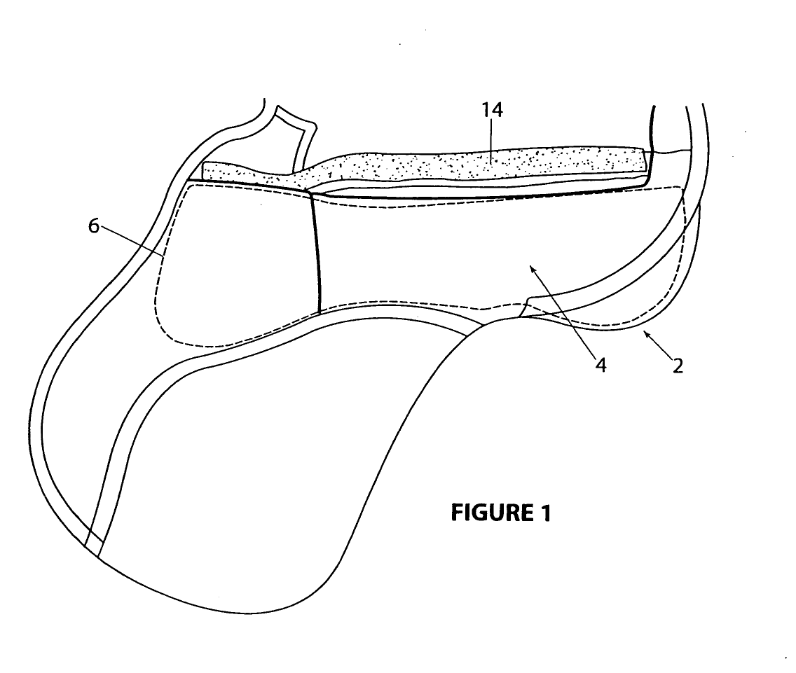

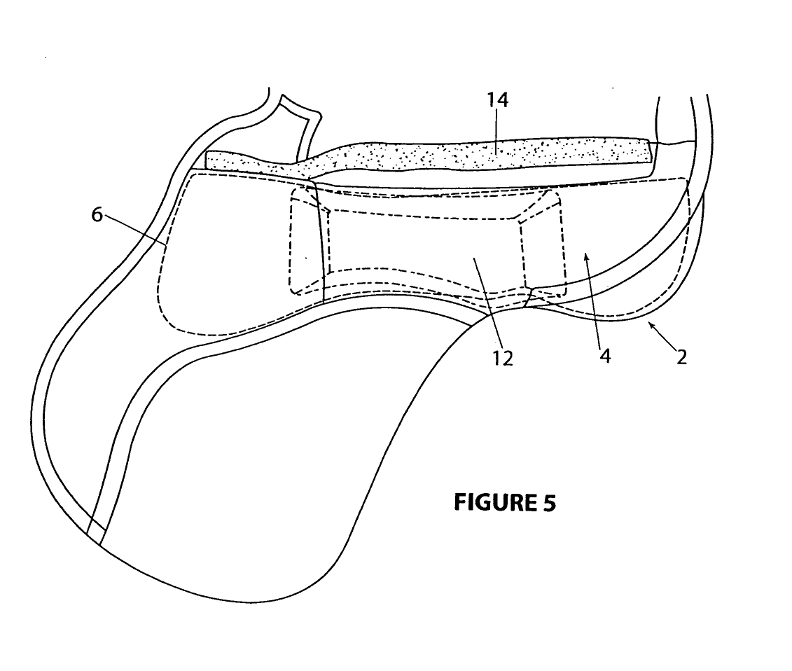

It is envisaged that the foam inserts will be produced in different thicknesses, for example 4 mm and 8 mm, so that a saddler will have a range of options for packing the panel by selecting required inserts of appropriate thickness. A saddler may, for instance, decide that packing is just required in the central part of the panel in which case only a central insert 12 of appropriate thickness is inserted. This is shown in FIG. 1. Alternatively it might be decided that uniform packing is required throughout the length of the panel in which case rear and forward overlapping inserts 8, 10 may be used without the central insert. This is shown in FIG. 5. In other situations a central insert can be used in conjunction with rear and forward inserts in order to provide packing of greater thickness within the central part of the panel. Inserts of mirror-image form may also be placed back-to-back to provide increased thickness so that, for example, inserts of 4 mm and 8 mm can be combined to provide a total thickness of 12 mm, or 2 inserts of 8 mm can be combined to form a thickness of 16 mm.

The use of these packing inserts which are formed from sheet material of uniform thickness inserted into the pocket 4 to the outside of the lining of the air bag unit means that it is not, in practice, possible to overfill the pocket with the result that the air bags will not be subject to any substantial loading when the saddle is not in use. More particularly, the air bags will remain substantially at atmospheric pressure internally during that mode.

As mentioned previously, the two or more air bags for insertion into the pocket in the panel are combined into a single unit by attachment to a lining. In one form, that lining layer might consist of or include a resiliently compressible open cell foam and is of substantially even thickness throughout so that the entire bag unit is itself of substantially even thickness throughout its length and width. However, in another form the lining is of composite form of varying thickness to compensate somewhat for excessive bow at the base of some forms of saddle tree. In this respect, some saddle trees which have been designed for use with conventional wool filled panels may not, due to a significant bowed shape at their base, be particularly suitable for use with the air bags and the lining arrangement can be shaped to compensate for that excessive bow. For this purpose, the inner surface of an outer lining is built-up by the attachment of wedges of sheet material at the forward and rear parts of the lining so that the inner surface provides a generally concave profile from its forward end to its rearward end. That inner surface of the entire lining structure is then permanently adhered to the air bags. The wedges themselves are composed of the same type of relatively firm foam as used for the replaceable inserts. In one form, the lining layer to which the wedges are attached permanently is a felt or similar type of material.

The air bag unit and inserts are retained in the pocket 4 by a flap 14 which closes the pocket and which is held in position by a suitable fastening, for example a hook and loop type fastening of the type sold under the trade mark “VELCRO”. The pocket and closure flap are accessible from the upper or outer side of the panel for adjustment of the packing by insertion and removal of the foam inserts when the panel has been detached from the saddle. To facilitate easy and quick detachment and re-attachment it is especially preferred that the two panels are combined to form a panel assembly which is stiffened around its rear edge by a rod or wire which permits attachment to the seat to be achieved by just a few screws (typically 3 or 4) driven into the saddle tree. Such a fixing system is described in our U.S. Pat. No. 6,725,636. The disclosure of which is hereby incorporated by reference.

The flap 14 closes the pocket by being folded over the top of the pocket 4 to be retained in position against the outer face of the pocket by the “VELCRO” or similar fastener. The length of the flap is such that even when the pocket contains a substantial thickness of insert, say 16 mm or more, it can still be folded over to close the pocket without unduly tensioning the material of the panel and which, if that were to occur, could lead to a permanent compressive loading on the air bags which would tend to diminish their effectiveness. It will be understood that the “VELCRO” or similar fastening will allow for a wide range of fastening positions between the flap and outer surface of the pocket to best suit the particular thickness of insert within the pocket.

The packing system described herein involving selection from a series of pre-formed foam inserts in conjunction with the air bags themselves for which no adjustment is required or possible, significantly reduces the skill levels needed to adjust the fit of the saddle to the horse during the life of the saddle. Also, the use of the quick-release and attachment system of our U.S. Pat. No. 6,725,636 to permit removal of the panels for re-packing and their re-attachment when that has been completed avoids the need for skilled labour for that process unlike traditional panel attachment methods involving stitching or stapling. Accordingly the entire process can be undertaken by relatively unskilled labour.

The embodiment has been described by way of example and modifications are possible within the scope of the invention.

1. A saddle for equestrian use, the saddle having panels, each panel containing a plurality of sealed air bags each serving in use to apply a relatively even pressure to the back of the horse, each air bag being substantially flat and being substantially filled within its interior with a resiliently compressible open cell foam, with each air bag being filled with a predetermined volume of air at substantially atmospheric pressure at the time of manufacture without the need for inflation to a higher pressure for usage of the air bags, each panel also including packing at a side of the air bags remote from the horse, wherein the packing consists of one or more inserts of sheet-like material removably inserted into the panel to permit adjustment of the packing by removal of one or more such inserts and/or the inclusion of one or more further such inserts.

2. A saddle according to claim 1, wherein the or each insert is fabricated from foam sheet material of substantially uniform thickness at least over a significant part of its area.

3. A saddle according to claim 1, wherein there are a series of inserts shaped for insertion into different parts of the panel, each insert is fabricated from sheet material composed of a relatively firm foam, and at least some of the inserts are chamfered along one or more of their edges.

4. A saddle according to claim 3, wherein two such inserts designed to overlap are formed with skives which overlap to form a skive joint to maintain a substantially uniform thickness over the length of the two combined inserts.

5. A saddle according to claim 4 in combination with a group of inserts for each panel and shaped for insertion into different parts of the panel, the inserts designed for insertion into a predetermined part of the panel being provided in a range of at least two different thickness whereby adjustment of the packing to adjust the fit of a saddle occurs by selection of an appropriate insert of the appropriate thickness and insertion of that or those inserts into the panel.

6. A saddle according to claim 5, wherein the inserts include an insert shaped for insertion into the forward part of the panel, an insert shaped for insertion into the rear part of the panel, and an insert shaped for insertion into the central part of the panel.

7. A saddle according to claim 1, wherein the air bags are combined into an air bag unit which is substantially flat and the unit is inserted into a pocket extending lengthwise in the panel, the air bag unit includes a protective lining layer at the side of the air bags remote from the horse, and the inserts are inserted into the pocket to lie between the lining layer and an adjacent side of the pocket to lie substantially flush against the lining layer.

8. A saddle according to claim 7, wherein wedges of sheet material are permanently interposed between the air bags and the lining layer to compensate for a substantially bowed shape of the base of a saddle tree to which it is adjacent.

9. A saddle for equestrian use having within each of its panels sealed air bags which serve to apply a relatively even pressure to the back of the horse in use of the saddle, the air bags are within a pocket in the panel and the pocket contains adjustable packing formed by one or more replaceable foam inserts selectively insertable into the pocket to lie at the side of the air bags remote from the horse.

10. A saddle according to claim 9, wherein the pocket is closed by an adjustable closure flap which folds over an opening in the pocket to be secured in an adjustable position against an upper surface of the panel.

11. A method of adjusting the packing of a saddle for equestrian use, the saddle having panels, each panel containing a plurality of sealed air bags each serving in use to apply a relatively even pressure to the back of the horse, each air bag being substantially flat and being filled with a predetermined volume of air at substantially atmospheric pressure at the time of manufacture, the air bags being within a pocket which is also adapted to receive packing at a side of the air bags remote from the horse, wherein the packing consists of one or more inserts of foam sheet material selected from a group of such inserts shaped to fit into different parts of the pocket and of at least two different thicknesses, said method comprising removal of any existing inserts from the pocket and/or inserting into the pocket one or more inserts from the group of inserts in the or each selected position and to the selected thickness.

12. A group of foam inserts for use in adjusting the packing of a saddle according to claim 11.
